(19) United States
(12) Patent Application Publication
(10) Pub. No.: US 2007/0188029 A1
(43) Pub. Date: Aug. 16, 2007

(54) PUMP AND PUMPING SYSTEM

(75) Inventor: Yukinobu Kurita, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: NIDEC Sankyo Corporation

(21) Appl. No.: 11/675,745

(22) Filed: Feb. 16, 2007

(30) Foreign Application Priority Data
Feb. 16, 2006 (JP) 2006-039252

(51) Int. Cl. H02K 7/00; H02K 11/00; H02K 5/12; F04B 17/00

(52) U.S. Cl. 310/67 R; 310/68 B; 310/86; 310/68 R; 417/354; 417/423.7

(57) ABSTRACT

To provide a pump and pumping system in which the mounting efficiency is improved and which can be controlled without pulling out a flexible tape, etc. from a pump in order to satisfy a demand for smaller information systems and a demand for mounting various kinds of electronic components with high density. A pump comprising an impeller having a plurality of vanes around its outer circumference and a rotor magnet on its inner circumference, a plurality of salient poles positioned opposite to the rotor magnet to radially extend outwardly in the radial direction of the impeller, a pump casing interposed between the rotor magnet and the plurality of salient poles, a driving IC for supplying current to coils wound around the salient poles, and an electronic board on which the driving IC is mounted; wherein the electronic board is fixed to the pump casing while the driving IC is interposed between the plurality of salient poles.

### CROSS-REFERENCE TO RELATED APPLICATION

This application claims priority of Japanese Application No. 2006-039252, filed Feb. 16, 2006, the complete disclosure of which is hereby incorporated by reference.

### BACKGROUND OF THE INVENTION

a) Field of the Invention

The present invention relates to a pump and pumping system used for the circulation of coolant that cools down electronic components and for the circulation of fuel cells; particularly, it relates to a pump and pumping system with an improved mounting efficiency.

b) Description of the Related Art

In recent years, as information systems are improved for higher performance and with more advanced features, heat generation is increased in the electronic components inside the information systems, and cooling devices are becoming more and more important. For example, the clock frequency of a CPU is much larger than before, and so a cooling method which cools down LSI by circulating the coolant inside the information system, is utilized. Also, fuel cells have been rapidly developing recently. Fuel cells are batteries which produce electricity by circulating fuel, are being smaller and smaller and increasingly built into data process terminals such as laptop computers and PDAs.

In many cases, a small pump is used to circulate such coolant or fuel. By installing a small pump in an information system, the coolant or fuel is circulated inside the information system (for example, see Laid-Open Japanese Patent Application No. 2003-161284 (FIG. 1)).

A thin vortical pump disclosed in this reference has a magnet and rotor built into a space created by a pump casing and a cover. Also, outside the space created by the pump casing and the cover, a stator is arranged opposite to the magnet. With this configuration, when current is sent to the stator, the rotor is rotated by the electromagnetic interaction of the stator and the magnet to circulate the coolant or fuel.

Although not disclosed in this reference, a flexible tape or a lead wire is pulled out from the pump to supply current to the above mentioned stator. Then, the flexible tape or lead wire that has been pulled out is connected to a process circuit (a driving IC, etc.) positioned away from the pump on the electronic board.

However, if a pump is arranged away from a process circuit that includes the driving IC, a bigger electronic board is required, not satisfying the demands of making small information systems and the demand of highly dense mounting of various kinds of electronic components.

Also, in a conventional method in which a flexible tape or lead wire is pulled out from a pump, electric signals sent through the flexible tape or lead wire may cause noise in an electronic board. The noise may cause defective operation or failure in various kinds of electronic components.

### OBJECT AND SUMMARY OF THE INVENTION

The present invention is devised taking the above problems into consideration; and has, as a primary object, to provide a pump and pumping system in which the mounting efficiency is improved so as to satisfy the demand of making small information systems or the demand of highly dense mounting of various kinds of electronic components and also which can be controlled without pulling a flexible tape, etc. out from the pump.

To achieve the above object, the present invention provides as follows:

(1) A pump comprising an impeller having a plurality of vanes formed around its outer circumference and a rotor magnet provided in its inner circumference, a plurality of salient poles which are arranged opposite to the rotor magnet and radially extend outwardly in the radial direction of the impeller, a pump casing interposed between the rotor magnet and the plurality of salient poles, a driving IC which supplies current to coils wound around the plurality of salient poles, and an electronic board on which the driving IC is mounted;

wherein the electronic board is fixed to the pump casing while the driving IC is interposed between the plurality of salient poles.

According to the present invention, a pump comprises an impeller having a rotor magnet around its inner circumference, a plurality of salient poles (a portion of a stator) arranged opposite to the rotor magnet, a pump casing interposed between the rotor magnet and the plurality of salient poles, and a driving IC mounted on an electronic board to supply current to coils wound around the plurality of salient poles; and the electronic board is fixed to the pump casing while the driving IC is interposed between the plurality of salient poles. Therefore, the mounting efficiency can be improved to make smaller information systems and to mount various kinds of electronic components with high density.

In other words, the electronic board to which the driving IC is mounted is fixed to the pump casing which is a constituent of the pump; as a result, the process circuit that includes the driving IC and the pump can be integrated. Therefore, current can be supplied to the coils wound around the plurality of salient poles without pulling a flexible tape or lead wire out from the pump like a conventional board. Consequently the mounting efficiency can be improved to make smaller information systems and to mount various kinds of electronic components with high density (or in an optimal arrangement).

Particularly since the driving IC is interposed between the plurality of salient poles in the present invention, different from the configuration in which the electronic board is fixed to the top surface or bottom surface of the pump casing to unite the process circuit that includes the driving IC with the pump, the thickness (in the axial direction of the impeller) of the pump casing can be small, contributing to making the entire pump thin. This increases further improvements of the mounting efficiency and possibilities of thinner information systems.

Also, there is no need to pull a flexible tape or lead wire out of the pump in the present invention; therefore, no noise will be generated on the electronic board, thus preventing defective operations and failure of the electronic components.

(2) A pump comprising an impeller having a plurality of vanes formed around its outer circumference and a rotor magnet provided in its inner circumference, a plurality of salient poles which are arranged opposite to the rotor magnet and radially extend outwardly in the radial direction of the impeller, a pump casing interposed between the rotor magnet and the plurality of salient poles, a driving IC which supplies current to coils wound around the plurality of salient poles, an electronic board on which the driving IC is mounted, and a position detector which detects the position of the rotor magnet;

wherein the position detector is arranged opposite to a portion of the outer circumference of the electronic board and opposite to the rotor magnet via the pump casing.

According to the present invention, the position detector provided to the pump is arranged opposite to a portion of the outer circumference of the above mentioned electronic board and also opposite to the rotor magnet via the pump casing. Therefore, this promotes making the entire pump thin and further improves the mounting efficiency.

In other words, a position detector that detects the position of the rotor magnet is conventionally arranged at a place on the electronic board different from the place where the pump is arranged; however, in the present invention, it is positioned not on the board but in the vicinity of the side wall surface of the electronic board. This configuration can prevent the problem of the electronic board becoming bulky because of the existence of the position detector resulting in a thicker pump casing (in the axial direction of the impeller), and thus the mounting efficiency can be further improved.

(3) The pump as set forth in (1) or (2) above wherein a protrusion portion fitting-in hole is formed in the electronic board for fitting a protrusion portion of the pump casing thereinto, and when the electronic board is fixed to the pump casing, the protrusion portion projects by a predetermined height from the protrusion portion fitting-in hole.

According to the present invention, a protrusion portion fitting-in hole is formed in the electronic board for fitting a protrusion portion of the pump casing thereinto, and when the electronic board is fixed to the pump casing, the protrusion portion projects by a predetermined height from the protrusion portion fitting-in hole. With this configuration, when the pump is installed in an information system, the aforementioned protrusion portion functions as a support, preventing pressure from being applied directly to the electronic board. Thus, the durability of the pump can be improved as a whole.

(4) The pump as set forth in any of (1) through (3) above wherein a driving IC fitting-in hole is formed in the electronic board for fitting the driving IC thereinto, and the driving IC is fitted into the driving IC fitting-in hole.

According to the present invention, a driving IC fitting-in hole is formed in the electronic board for fitting the driving IC thereinto, and the driving IC is fitted into the driving IC fitting-in hole. Therefore, even if the driving IC is somewhat large, a thin pump can be made.

(5) A pumping system comprising any pump of (1) through (4) above, a control circuit which sends to the pump control signals that change the number of rotations of the impeller; wherein the pump has an FG terminal that outputs FG signals which periodically change according to the number of rotations of the impeller, and the control circuit sends the control signals based on the FG signals sent by the FG terminal.

According to the present invention, a pumping system comprises the above mentioned pump and a control circuit which sends to the pump control signals that change the number of rotations of the impeller; wherein the pump has an FG terminal that outputs FG signals which periodically change according to the number of rotations of the impeller, and the control circuit sends the control signals based on the FG signals sent by the FG terminal. Therefore, the control circuit can properly identify the number of rotations of the pump and at the same time the pump performance (the amount of ejection) can be properly controlled.

A pump of the present invention, as described above, is configured such that an electronic board is fixed to a pump casing while a driving IC mounted on the electronic board is interposed between a plurality of salient poles; therefore, the mounting efficiency can be improved, and smaller, thinner information systems can be made and various kinds of electronic components can be mounted with a highly dense, optimal arrangement.

An ideal form of an embodiment of the present invention is described hereinafter referring to the drawings.

### BRIEF DESCRIPTION OF THE DRAWINGS

In the drawings:

FIG. 1 is a diagram showing the mechanical structure of a pump of the embodiment of the present invention;

FIG. 2 is a diagram showing the electrical composition of a pump of the embodiment of the present invention;

FIG. 3 is a circuit diagram showing the electrical circuit of a pump of the embodiment of the present invention;

FIG. 4 is a diagram showing a summary of a pumping system of the embodiment of the present invention; and

FIG. 5 is a diagram to describe a pump of another embodiment of the present invention.

### DESCRIPTION OF THE PREFERRED EMBODIMENTS

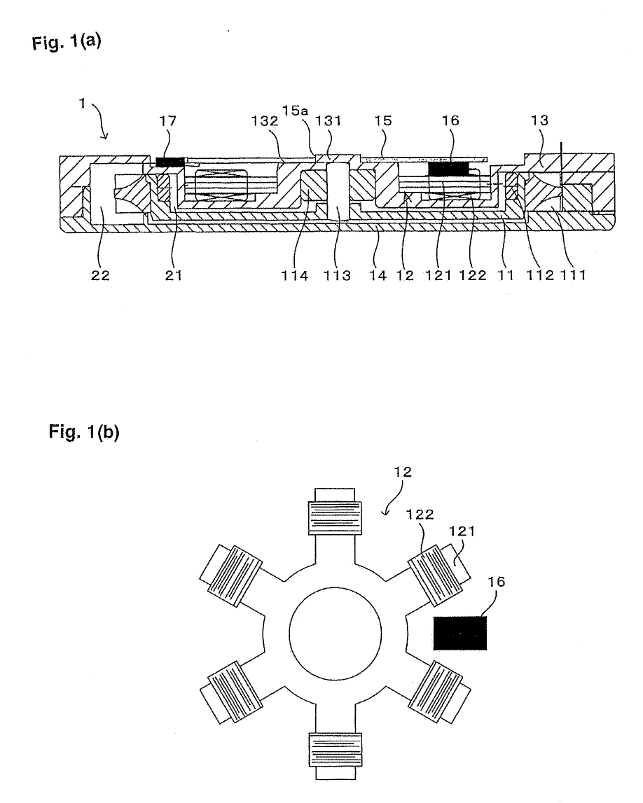

FIG. 1 is a diagram showing the mechanical structure of pump 1 of an embodiment of the present invention. In particular, FIG. 1(a) is a cross-sectional side view of the pump 1; FIG. (b) is a plan view showing the positional relationship of a stator 12 and a driving IC 16. Note that FIG. 1(a) shows the pump 1 upside down for convenience of description.

In FIG. 1(a), the pump 1 of this embodiment mainly comprises an impeller 11, a stator 12, a pump casing 13, and a bottom plate 14.

The impeller 11 has a plurality of vanes 111 around its outer circumference; as the impeller 11 is rotated, a turbulent flow is induced around the vanes 111. Note that the initial movement of the rotation can be smooth by applying a Teflon coating over the surface of the vanes 111.

Also, a rotor magnet 112 is attached to the inner circumference of the impeller 11. A rotational force is induced to the rotor magnet 112 according to the magnetic fields caused by the stator 12 so that the rotor magnet 112 and impeller 11 rotate together.

The impeller 11 is fixed to a shaft 113 which is rotatably supported by a radial bearing 114. Note that although the radial bearing 114 is composed of an oil-less bearing in this embodiment, a bearing other than an oil-less bearing, such as a ball bearing, may be used. This prevents the impeller 11 from swinging up and down while rotating, and consequently preventing the generation of strange noise due to collisions and the degrading of the rotation efficiency.

The stator 12 is arranged opposite to the rotor magnet 112, and in this embodiment it has six salient poles 121 that radially extend outwardly in the radial direction of the impeller 11. The appearance of the configuration is as seen in FIG. 1(b). A coil 122 is wound around each of the six salient poles; by passing electricity to the coil 122, a magnetic field is induced in the vicinity of the stator 12.

The pump casing 13 is for airtight separation of the stator 12 from a rotor area 21 and a pump chamber 22: to the stator 12, current is supplied; in the rotor area 21, the impeller 11 is placed, and in the pump chamber 22, a fluid such as coolant or fuel is circulated. In this way, the fluid such as coolant or fuel is prevented from attaching to the stator 1, which may cause the stator 12 to fail. In other words, the pump casing is interposed between the rotor magnet 112 and the plurality of salient poles 121.

Note that the pump chamber 22 is an area in which a fluid such as coolant or fuel, which flows in from an inlet (not illustrated) and flows out from an outlet (not illustrated), is circulated by turbulent flows. The pump chamber 22 is created as the pump casing and a bottom plate 14 are fixed to each other. It is preferred from a viewpoint of light weight that the pump casing 13 be made of synthetic resin; however, it may be made of a metallic material such as copper or aluminum.

A space (recessed portion) is created outside the pump casing 13 (the top side in FIG. (a)) for the stator 12 to be inserted thereto. With this configuration, a protrusion 131 formed in the center of the pump casing 13 is positioned around the annular center of the stator 12 as illustrated in FIG. 1(b).

Also, an electronic board 15 on which a driving IC 16 is mounted is fixed to a step portion 132 adjacent to the protrusion portion 131. More specifically described, a first fitting-in hole 15a which is a protrusion portion fitting-in hole is formed in the center of the electronic board 15 for fitting the protrusion portion 131 of the pump casing 13 thereinto in this embodiment; when the pump casing 13 is fixed to the step portion 132, the protrusion portion 131 projects from the first fitting-in hole 15a by a predetermined height. Therefore, when the pump 1 is installed in an information system, the protrusion portion 131 functions as a support, preventing pressure from being directly applied to the electronic board 15. This improves durability of the pump 1 as a whole.

In the pump 1 of this embodiment, the electronic board 15 is fixed to the pump casing 13 while the driving IC 16 is interposed between the plurality of salient poles 121 (see FIG. 1(b)).

In other words, a cross-sectional side view of the pump illustrated in FIG. 1(a) appears as if the driving IC 16 is fitted into the coil 122 which is a portion of the stator 12 (or the coil 122 and salient pole 121). Therefore, the thickness of the pump casing 13 (in the axial direction of the shaft 113) can be made thin, contributing to a thinner pump 1 as a whole. This results in the improvement of the mounting efficiency and in a thinner information system. Also, since the pump casing 13 is integrated with the electronic board 15, there is no need to pull a flexible tape or lead wire out from the pump 1 as in a conventional pump and noise is prevented from being generated on the electronic board 15, further preventing a defective operation or failure of the electronic components.

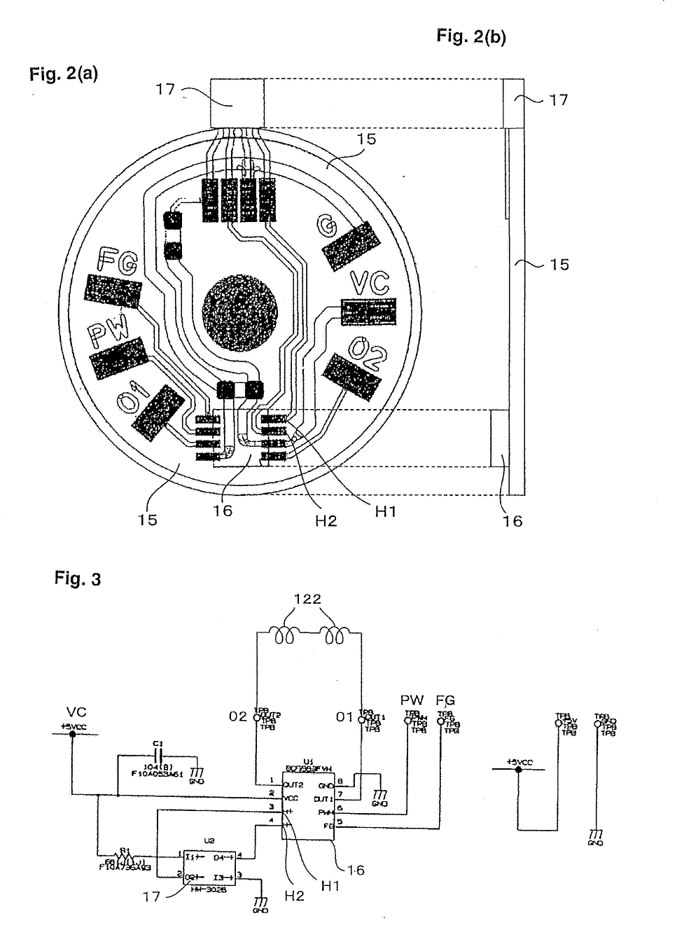

Also, the pump 1 of this embodiment has a position detector that detects the position of the rotor magnet 112, and it is a Hall device 17 in this embodiment; the Hall device 17 is arranged opposite to a portion of the outer circumference of the electronic board 15 and also opposite to the rotor magnet 112 via the pump casing 13 (see FIG. 1(a)). Specifically, as illustrated in FIG. 2, the terminal portion of the Hall device 17 is arranged on the electronic board 15 and the main portion of the device 17 is arranged around the outer circumference of the electronic board 15; in other words, the thickness of the Hall device 17 is absorbed in the thickness of the electronic board 15 so that the Hall device 17 is kept as much as possible from projecting in the thickness direction of the electronic board 15. This configuration can prevent the electronic board 15 from getting bulky due to the presence of the Hall device 17, thus preventing the pump casing 13 or the pump 1 from being thick.

Note that although the Hall device 17 is used for a position detector in this embodiment, other position detectors such as a hall IC may be used as long as they are of a shape and size such that the electronic bard 15 is prevented from being thick.

An electrical composition of the pump 1 is described in detail hereinafter.

FIG. 2 is a diagram showing an electrical composition of the pump 1 of the embodiment of the present invention. FIG. 3 is a circuit diagram showing an electrical circuit of the pump 1 of the embodiment of the present invention.

In FIG. 2, the electrical circuit of the pump 1 is mainly composed of the electronic board 15 which has the driving IC 16 for supplying current to the coils 122 and the Hall device 17 as a position detector for detecting the position of the rotor magnet 112. Note that FIG. 2(b) is a view of the electronic board 15 illustrated in FIG. 2 (a) seen from the side, as illustrated in FIG. 2(b) (or as described above), the Hall device 17 is arranged opposite to a portion of the outer circumference of the electronic board 15.

In FIG. 3, the driving IC 16 mounted on the electronic board 15 has eight terminals (pins) in total: 01 terminal, 02 terminal, VC terminal, G terminal, H1 and H2 terminal (for the hall device), FG terminal and PW terminal.

The 01 terminal and the 02 terminal are connected to the coil 122 to supply current to rotate the rotor magnet 112. The VC terminal and the G terminal are respectively a terminal to receive power supply and a grounding terminal. The H1 terminal and the H2 terminal are for receiving electric signals from the Hall device 17 which is an electromagnetic converter that uses the Hall effect. Note that the Hall device 17 can be of InSb type or GaAs type or of any other types.

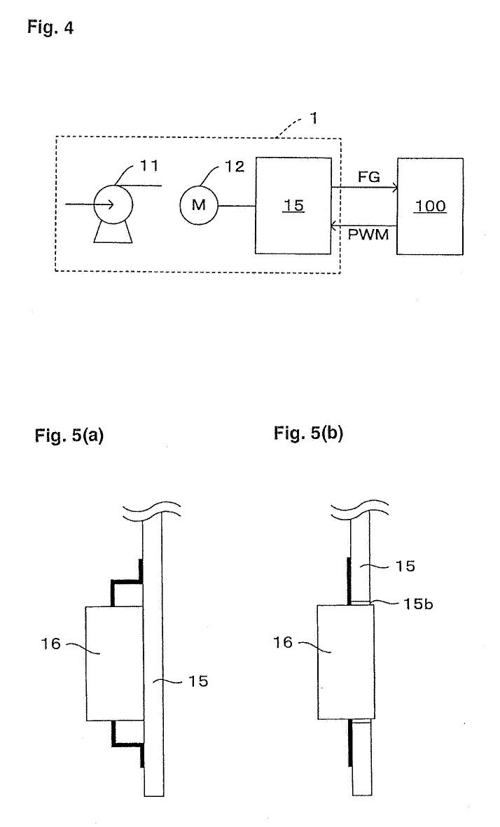

The FG terminal is an output terminal that outputs Frequency Generator (FG) signals, that is, signals which periodically change according to the number of rotations of the impeller 11. FG signals are produced in the driving IC 16 based on the electric signals sent by the Hall device 17. The PW terminal is a terminal that receives PWM (Pulse Width Modulation) signals from a control circuit 100 (see FIG. 4 to be described later) which is a host circuit, that is, the control signals that change the number of rotations of the impeller 11. The driving IC 16 of the pump 1 is PWM-controlled through the PW terminal. Note that the PWM-control is a method of controlling the power supply by changing a voltage pulse width ratio (a so-called duty ratio).

FIG. 4 is a diagram showing a summary of a pumping system of the embodiment of the present invention. This pumping system is mainly composed of the pump 1 and a control circuit 100; in this embodiment, it is composed of the impeller 11 that circulates coolant or fuel, the stator 12 (of a motor) that electromagnetically gives a rotational force to the impeller 11, the electronic board 15 on which the driving IC 16 for supplying current to the coils 122 of the stator is mounted, and a control circuit 100 that sends control signals to the electronic board 15. The operation of this pumping system is described using FIG. 3 and FIG. 4.

First the control circuit 100 sends to the driving IC 16 a control signal that starts the rotation of the impeller 11. The control signal is received by the PW terminal of the driving IC, and then current is supplied to the coils 122 through the 01 terminal and the 02 terminal of the driving IC 16. With this, magnetic fields are induced to the coils 122; by reacting to the magnetic fields, a repelling force is generated to the rotor magnet 112, with which the impeller 11 having the rotor magnet 112 attached thereto starts rotating. As the impeller 11 is rotated in the pump chamber 22, a turbulent flow is induced to circulate coolant or fuel inside the pump chamber 22. Thus, the coolant or fuel that has flowed in from an inlet passes through the pump chamber 22 and then is ejected to the outside from an outlet.

Here it is described how to increase the number of rotations of the impeller 11. The control circuit 100 receives FG signals output by the FG terminal of the driving IC 16 as described above. Based on the FG signals, desired PWM signals (the signals having a larger duty ratio) are generated. The control circuit 100 sends the generated PWM signals to the PW terminal of the driving IC 16. The driving IC 16 that has received the signals increases the amount of current to be supplied to the coils 122 based on the PWM signals. This results in increasing the number of rotations of the impeller 11. The same process can be used when decreasing the number of rotations of the impeller 11. In other words, PWM signals having a smaller duty ratio are sent to the driving IC 16 from the control circuit 100 to decrease the number of rotations of the impeller 11.

As described above, according to the pumping system of the embodiment of the present invention, the control circuit 100 properly identifies the number of rotation of the pump 1 (impeller 11) through the FG signals, and at the same time the pumping performance (the amount of ejection) can be properly controlled with the PWM signals.

FIG. 5 is a diagram to describe a pump 1A of another embodiment of the present invention. In particular, FIG. 5(a) is a cross-sectional side view of the driving IC 16 of the pump 1 of the above mentioned embodiment; FIG. 5(b) is a cross-sectional side view of a driving IC 16 of a pump 1A of another embodiment of the present invention.

As illustrated in FIG. 5(b), a driving IC 16 of a pump 1A is fitted into the electronic board 15. In other words, a second fitting-in hole 15b is formed in the electronic board 15 for inserting the driving IC 16 thereto; and the driving IC 16 is fitted into the second fitting-in hole 15b. With this, even when the driving IC is somewhat large, a pump can be made thin.

Note that although a single-phase full-wave driving method is considered as a method for driving the pump 1 of this embodiment, the present invention is not limited to this, but a double-phase full-wave (half-wave) driving method or a three-phase full-wave (half-wave) driving method may be considered. Also, a blushless motor can be used as well.

The pump and pumping system of the present invention is useful to improve the mounting efficiency of electronic components such as a driving IC or a hall device.

While the foregoing description and drawings represent the present invention, it will be obvious to those skilled in the art that various changes may be made therein without departing from the true spirit and scope of the present invention.

What is claimed is:

1. A pump comprising:
an impeller in which a plurality of vanes are formed around its outer circumference and a rotor magnet is provided in its inner circumference;
a plurality of salient poles which are arranged opposite to said rotor magnet and radially extend outwardly in the radial direction of said impeller;
a pump casing interposed between said rotor magnet and said plurality of salient poles;
a driving IC which supplies current to coils wound around the said plurality of salient poles; and
an electronic board on which said driving IC is mounted;
wherein said electronic board is fixed to said pump casing while said driving IC is interposed between the said plurality of salient poles.

2. A pump comprising:
an impeller in which a plurality of vanes are formed around its outer circumference and a rotor magnet is provided to its inner circumference;
a plurality of salient poles which are arranged opposite to said rotor magnet and radially extend outwardly in the radial direction of said impeller;
a pump casing interposed between said rotor magnet and said plurality of salient poles;
a driving IC which supplies current to coils wound around the said plurality of salient poles;
an electronic board on which said driving IC is mounted; and
a position detector which detects the position of said rotor magnet;
wherein said position detector is arranged opposite to a portion of the outer circumference of said electronic board and opposite to said rotor magnet via said pump casing.

3. The pump as set forth in claim 1 wherein a protrusion portion fitting-in hole is formed in said electronic board for fitting a protrusion portion of said pump casing thereinto, and when said electronic board is fixed to said pump casing, said protrusion portion projects by a predetermined height from said protrusion portion fitting-in hole.

4. The pump as set forth in claim 2 wherein a protrusion portion fitting-in hole is formed in said electronic board for fitting a protrusion portion of said pump casing thereinto, and when said board is secured to said pump casing, said protrusion portion projects by a predetermined height from said protrusion portion fitting-in hole.

5. The pump as set forth in claim 1 wherein a driving IC fitting-in hole is formed in said electronic board for fitting said driving IC thereinto, and said driving IC is fitted into said driving IC fitting-in hole.

6. The pump as set forth in claim 2 wherein a driving IC fitting-in hole is formed in said electronic board for fitting said driving IC thereinto, and said driving IC is fitted into said driving IC fitting-in hole.

7. The pump as set forth in claim 3 wherein a driving IC fitting-in hole is formed in said electronic board for fitting said driving IC thereinto, and said driving IC is fitted into said driving IC fitting-in hole.

8. The pump as set forth in claim 4 wherein a driving IC fitting-in hole is formed in said electronic board for fitting said driving IC thereinto, and said driving IC is fitted into said driving IC fitting-in hole.

9. A pumping system comprising:
a pump of claim 1;
a control circuit which sends to said pump control signals that change the number of rotations of said impeller;
wherein said pump has an FG terminal that outputs FG signals which periodically change according to the number of rotations of said impeller, and said control circuit sends said control signals based on FG signals sent by said FG terminal.

10. A pumping system comprising:
a pump of claim 2;
a control circuit which sends to said pump control signals that change the number of rotations of said impeller;
wherein said pump has an FG terminal that outputs FG signals which periodically change according to the number of rotations of said impeller, and said control circuit sends said control signals based on FG signals sent by said FG terminal.
